(19) United States
(12) Patent Application Publication
(10) Pub. No.: US 2004/0115415 A1
(43) Pub. Date: Jun. 17, 2004

(54) Insulative stone composite slabs

(76) Inventors: Lothar Thiele, Langenfeld (DE); Jorg Herzog, Cottbus (DE); Andre Te Poel, Willich (DE)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/457,689

(22) Filed: Jun. 9, 2003

Related U.S. Application Data
(63) Continuation-in-part of application No. PCT/EP01/13894, filed on Nov. 28, 2001.

(30) Foreign Application Priority Data
Dec. 7, 2000 (DE) 10060817.5

(51) Int. Cl. B32B 3/26

(52) U.S. Cl. 428/304.4

(57) ABSTRACT

Composite bodies are provided from a shaped mineral body and a foamed polyurethane layer. Processes for their production are disclosed. The composite bodies are suitable, inter alia, as facade, floor or wall panels.

This application is a continuation-in-part of International Application Serial Number PCT/EP01/13894, filed Nov. 28, 2001, which claims priority under 35 U.S.C. 119 (a)-(d) to DE 100 60 817.5, filed Dec. 7, 2000. the contents of each are incorporated by reference herein in their entireties.

### FIELD OF THE INVENTION

The present invention relates to processes for the production of composite bodies from a shaped mineral body and a foamed layer, to the composite bodies produced by these processes, and to uses for the composite bodies thus produced.

### BACKGROUND OF THE INVENTION

Facade, floor or wall panels are often made of natural stone slabs or shaped natural stone bodies, such as marble, granite, soapstone, basalt or sandstone. To achieve an adequate load-bearing capacity and flexural strength, these mineral slabs or shaped mineral bodies must have considerable layer thicknesses for the abovementioned intended uses. As a consequence, such slabs or semi-finished products in slab form for this purpose are expensive and have substantial weight. Moreover, these mineral slabs or shaped mineral bodies with considerable layer thicknesses do not have a low thermal conductivity that is often desirable for facade, floor or wall panels in order to provide insulation to buildings. These two factors limit the usability of such compact natural stone products.

DE-C-197 26 502 discloses a process for the production of sheets or mouldings of polyisocyanates and polyols which react to form a polyurethane foam plastic, imitation stone being formed by admixing of fillers, dyestuffs and the like. Additionally, the foamed polyurethane mixture may be joined to a natural stone slab, e.g., of granite or marble, or to metal or a wood material in a heated mould in an in-mould process. To join the foamed mixture and natural stone slab, the mould containing the foamed mixture and natural stone slab necessarily must be heated to maintain a temperature of between 55 and 80° C. and exposed to a pressure of between 7 MPa and 14 MPa, by the foaming in the heated mould, in order to achieve a density of between 0.4 g/cm³ and 2.0 g/cm³. Regarding the foam components, it is only generally stated that a polyisocyanate and a polyol are employed, and further details cannot be discerned from this reference.

DE-A-19610262 discloses a process for the preparation of rigid polyurethane foams from polyols, polyisocyanates, blowing agents and optionally foam auxiliaries. The utilized polyol component has on average at least 3 hydrogen atoms and contains 60 to 100% of polyether and/or polyester of molecular weight 250 to 1,500 with at least 2 hydroxyl groups. The polyols also have a surface tension of 6 to 14 mN/m with respect to the blowing agent. A polyisocyanate with an NCO content of 20 to 48 wt. %, which has a surface tension of 4.0 to 8 mN/m with respect the blowing agent, is mentioned as a further reaction component. The composition utilized in the disclosed process further comprises i- and/or n-pentane as the blowing agent, water, and optionally, auxiliary substances and additives. Use of these rigid foams as an intermediate layer for composite elements and for filling hollow spaces with foam in domestic refrigerator construction is proposed. The production of stone composite slabs is not disclosed.

In a similar manner, the patent specifications DE 4303659 C2, DE 19611367 A1, DE 19546461 A1, DE 197 09868 A1 and WO 94/014179 disclose processes for the preparation of rigid foams in the presence of organic blowing agents. The intended use of these rigid foams is for the production of composite elements, particularly, for domestic refrigerator construction.

DE-A-19918459 discloses a process for the production of composite bodies from shaped mineral bodies and foamed polyurethane layers. The foamable polyurethane-forming mixture comprises polyisocyanates, polyols, catalysts, wetting and dispersing agents, foam stabilizers, water and/or carboxylic acids and, preferably, fillers. In this process, the mould for production of the composite body does not require preheating, and the composition is exposed only to the intrinsic pressure arising during the foaming process. Although this production process produces quite usable results, it has been found that the foamable polyurethane-forming mixture tends to demix, so that it cannot be stored for a relatively long period of time and must be homogenized thoroughly by intensive stirring immediately before use.

There is still an unfilled need for simple, stable and efficient processes for the production of strong, lightweight composite bodies from foamable compositions and shaped mineral bodies. In certain applications, improved insulation properties of the composite bodies are desirable. The present invention is directed to these, as well as other important ends.

### SUMMARY OF THE INVENTION

Accordingly, the present invention is directed in part to processes for the production of composite bodies comprising introducing into a closed, substantially unheated, mould a foamable composition comprising at least one polyisocyanate, and at least one polyol, together with long—chain acid, amine and low—boiling hydrocarbon. The composition is then foamed in the mould under pressure intrinsic to the foaming reaction to form a foamed layer. It is then adhered to a shaped mineral body to provide the composite body.

In another embodiment, the composite bodies are provided comprising a shaped mineral body adhered to a foamed layer formed by introducing into a closed, substantially unheated, mould a foamable composition comprising at least one polyisocyanate, and at least one polyol, together with long—chain acid, amine and low—boiling hydrocarbon; and foaming the composition in the mould under pressure intrinsic to the foaming reaction to form the foamed layer.

### BRIEF DESCRIPTION OF THE DRAWINGS

FIG. 1 depicts an exemplary composite body in accordance with a preferred embodiment of this invention.

### ILLUSTRATIVE EMBODIMENTS

Accordingly, the present invention is directed in part to processes for the production of composite bodies comprising introducing into a closed, substantially unheated, mould a foamable composition comprising at least one polyisocyanate, and at least one polyol, together with long—chain acid, amine and low—boiling hydrocarbon. The composition is then foamed in the mould under pressure intrinsic to the foaming reaction to form a foamed layer. It is then adhered to a shaped mineral body to provide the composite body.

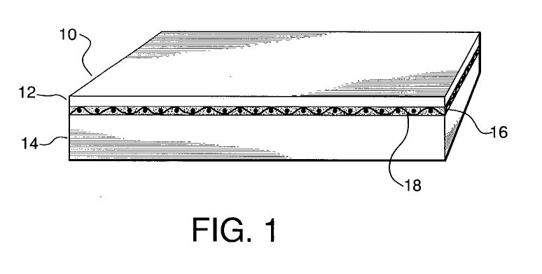

FIG. 1 shows an exemplary composite body, 10 in accordance with a preferred embodiment of this invention. A shaped mineral body, 12, which may be stone, e.g. marble, granite, soapstone, sandstone, or other type of decorative or architectural stone, is adhered to a foamed layer, 14. The foamed layer gives the composite body flexural and structural strength as well as insulative properties. In accordance with certain preferred embodiments, adhesion takes place through the interposition of an adhesive layer, 16. In accordance with certain preferred embodiments, a reinforcing mat or layer, 18, which may be woven or non-woven fabric, metal or glass mesh or other relatively strong material, is disposed within the adhesive layer to provide improved strength and durability to the composite body.

In a preferred embodiment of the process for the production of the composite body described above, the shaped mineral body is adhered to the foamed layer with a layer of polyurethane adhesive similar to the foamable composition having no blowing agent. More preferably, a woven or non-woven reinforcing mat or layer is adhered between the foamed layer and the shaped mineral body with the layer of polyurethane adhesive. Even more preferably, another woven or non-woven reinforcing mat or layer is disposed upon the foamed layer on the side away from the shaped mineral body.

In another preferred embodiment of the process for the production of the composite body described above, the foamable composition further comprises at least one filler. More preferably, the filler is calcium carbonate in the form of chalk or ground limestone, calcium magnesium carbonate, barium sulfate, aluminum oxide, hydrated aluminum oxide, quartz sand, dried abraded stone sediment, ground glass, foamed glass granules, wood chips, wood flour, cellulose fibers, foam waste, rubber flour, rubber chips, compact waste from plastics, cable waste, short fibers of glass or rock wool synthetic polymer fibers, natural fibers or mixtures thereof.

In another preferred embodiment of the process for the production of the composite body described above, the foamable composition comprises up to about 80% filler.

In another preferred embodiment of the process for the production of the composite body described above, the foamable composition further comprises at least one catalyst, carboxylic acid, water (up to about 5 weight percent), amine, foam stabilizer, wetting agent and dispersing agent.

In another preferred embodiment of the process for the production of the composite body described above, the low boiling hydrocarbon has from one to five carbon atoms. More preferably, the low boiling hydrocarbon is cyclopentane.

In still another preferred embodiment of the process for the production of a composite body described above, the foamable composition further comprises filler having a particle size distribution corresponding to a Fuller distribution or a gap grading.

In yet another preferred embodiment of the process for the production of the composite body described above, the composite body is produced in an essentially single operation comprising the steps of placing the shaped mineral body into the mould, introducing the foamable composition into the mould containing the shaped mineral body, and enclosing the mould. Foaming of the foamable composition in the closed mould containing the shaped mineral body is then effected. The composite body is then removed from the mould. Preferably, a layer of polyurethane adhesive is applied to the shaped mineral body before introduction of the foamable composition. More preferably, a woven or non-woven reinforcing mat or layer is applied to the layer of polyurethane adhesive prior to introduction of the foamable composition.

In an alternative embodiment of the process for the production of the composite body described above where the composite body is produced in an essentially single operation, a woven or non-woven reinforcing mat or layer is disposed upon the foamed layer on the side away from the shaped mineral body.

The present invention is also directed in part to composite bodies comprising a shaped mineral body adhered to a foamed layer formed by introducing into a closed, substantially unheated, mould a foamable composition comprising at least one polyisocyanate, and at least one polyol, together with long—chain acid, amine and low—boiling hydrocarbon; and foaming the composition in the mould under pressure intrinsic to the foaming reaction to form a foamed layer. Preferably, the shaped mineral body is adhered to the foamed layer with a polyurethane adhesive similar to the foamable composition having no blowing agent.

In an alternative preferred embodiment of the composite body described above, a woven or non-woven reinforcing mat or layer is adhered between the foamed layer and the shaped mineral body.

In an alternative preferred embodiment of the composite body described above, a woven or non-woven reinforcing mat or layer is disposed upon the foamed layer on the side away from the shaped mineral body.

In still another alternative preferred embodiment of the composite body described above, the foamable composition further comprises at least one filler. More preferably, The process according to claim 1 wherein the foamable composition comprises up to about 80% by weight filler.

In still another alternative preferred embodiment of the composite body described above, a wall or floor building panel comprises the composite body.

As employed above and throughout the disclosure, the following terms, unless otherwise indicated, shall be understood to have the following meanings.

As used herein, a “substantially unheated” mould, is a mould to which no additional extrinsic heat is applied. Residual heat retained in the mould from previous preparations of composite bodies made by the processes of the present invention are meant to be within the scope of the present invention.

As used herein, “alkyl” refers to an optionally substituted, saturated straight-chain, branched, or cyclic hydrocarbon having from about 1 to about 20 carbon atoms (and all combinations and subcombinations of ranges and specific numbers of carbon atoms therein). Alkyl groups include, but are not limited to, methyl, ethyl, n-propyl, isopropyl, n-butyl, isobutyl, t-butyl, n-pentyl, cyclopentyl, isopentyl, neopentyl, n-hexyl, isohexyl, cyclohexyl, cyclooctyl, adamantyl, 3-methylpentyl, 2,2-dimethylbutyl, and 2,3-dimethylbutyl.

As used herein, “cycloalkyl” refers to an alkyl radical having one or more rings in their structures having from about 3 to about 20 carbon atoms (and all combinations and subcombinations of ranges and specific numbers of carbon atoms therein), with from about 3 to about 10 carbon atoms being preferred. Cycloalkyl groups may be optionally further substituted with one or more alkyl groups. Multi-ring structures may be bridged or fused ring structures. Cycloalkyl groups include, but are not limited to, cyclopropyl, cyclobutyl, cyclopentyl, cyclohexyl, cyclooctyl, decalinyl, and adamantyl. Alkylene diradicals may be used to link two or more cycloalkyl or aryl groups.

As used herein, “alkylene” refers to a bivalent alkyl radical having the general formula —(CH₂)ₙ—, where n is 1 to 10. Non-limiting examples include methylene, trimethylene, pentamethylene, and hexamethylene. Alkylene groups may be optionally substituted with one or more alkyl groups.

As used herein, “aryl” refers to an optionally substituted, mono-, di-, tri-, or other multicyclic aromatic ring system radical having from about 5 to about 50 carbon atoms (and all combinations and subcombinations of ranges and specific numbers of carbon atoms therein), with from about 6 to about 10 carbons being preferred. Non-limiting examples include, for example, phenyl, naphthyl, anthracenyl, and phenanthrenyl.

As used herein, “foamed layer” refers to a reaction product comprising at least one polyol with at least one polyisocyanate, where water and/or carboxylic acid may optionally be co-used as a blowing agent for pore formation of the foam. Alternatively, hydroxycarboxylic acids or aminocarboxylic acids may be to replace polyols and carboxylic acids. Aminocarboxylic acids and hydroxycarboxylic acids differ in structure only that an amino (—NH₂) group replaces an hydroxyl (—OH) group in the corresponding hydroxycarboxylic acid. Polyols may be replaced entirely or in part by polyamines or aminopolyols, where one or more hydroxyl (—OH) groups is replace by an amino (—NH₂) group.

As used herein, “polyisocyanate” refers to an aryl, cycloalkyl or alkyl moiety substituted with at least two isocyanate (—N═C═O) functionalities. Preferably, the moieties are substituted with, on average, from two to five isocyanate functionalities. More preferably, they are substituted with, on average, from two to four isocyanate functionalities. Most preferably, they are substituted with, on average, from two to three isocyanate functionalities.

Exemplary aryl polyisocyanates include, but are not limited to, all isomers of toluene diisocyanate (TDI), either in the isomerically pure form or as a mixture of several isomers, naphthalene 1,5-diisocyanate, diphenylmethane 4,4′-diisocyanate (MDI), diphenylmethane 2,4′-diisocyanate and mixtures of diphenylmethane 4,4′-diisocyanate with the 2,4′ isomer or mixtures thereof with oligomers of higher functionality (so-called crude MDI), xylylene diisocyanate (XDI), diphenyl-dimethylmethane 4,4′-diisocyanate, di- and tetraalkyl-diphenylmethane diisocyanates, dibenzyl 4,4′-diisocyanate, phenylene 1,3-diisocyanate and phenylene 1,4-diisocyanate. Exemplary cycloalkyl polyisocyanates include, but are not limited to, the hydrogenation products of the abovementioned aryl diisocyanates, such as, for example, dicyclohexylmethane 4,4′-diisocyanate (H₁₂MDI), 1-isocyanatomethyl-3-isocyanato-1,5,5-trimethyl-cyclohexane (isophorone diisocyanate, IPDI), cyclohexane 1,4-diisocyanate, hydrogenated xylylene diisocyanate (H₆XDI), 1-methyl-2,4-diisocyanato-cyclohexane, m- or p-tetramethylxylene diisocyanate (m-TMXDI, p-TMXDI) and dimer fatty acid diisocyanate. Exemplary alkyl polyisocyanates include, but are not limited to, tetramethoxybutane 1,4-diisocyanate, butane 1,4-diisocyanate, hexane 1,6-diisocyanate (HDI), 1,6-diisocyanato-2,2,4-trimethylhexane, 1,6-diisocyanato-2,4,4-trimethylhexane, butane 1,4-diisocyanate and dodecane 1,12-diisocyanate (C₁₂DI).

Aryl polyisocyanates are in general preferred. More preferably, the aryl polyisocyanate is diphenylmethane 4,4′-diisocyanate (MDI), diphenylmethane 2,4′-diisocyanate, mixtures of diphenylmethane 4,4′-diisocyanate with the 2,4′ isomer, MDI liquefied with carbodiimide, which is known e.g. under the trade name ISONATE 143 L, or so-called “crude MDI”, i.e., an isomer/oligomer mixture of MDI, such as is commercially obtainable e.g. under the trade names PAPI and DESMODUR VK. So-called “quasi-prepolymers”, i.e. reaction products of MDI or TDI with low molecular weight diols, such as e.g. ethylene glycol, diethylene glycol, propylene glycol, dipropylene glycol or triethylene glycol, may furthermore be used. As is known, these quasi-prepolymers are a mixture of the abovementioned reaction products with monomeric diisocyanates. Surprisingly, alkyl and cycloalkyl polyisocyanates react rapidly and completely at room temperature to give the foams according to the invention. In addition to the abovementioned alkyl and cycloalkyl isocyanates, isocyanuration products and biuretization products thereof, in particular those of HDI and IPDI, may also be employed.

As used herein, “polyol” refers to an organic compound substituted with at least two hydroxyl groups and includes, but is not limited to, those polyols which are already known for the preparation of polyurethanes. Exemplary polyols include, but are not limited to, the polyhydroxy-polyethers, of the molecular weight range from 60 to 10,000, preferably 70 to 6,000, with 2 to 10 hydroxyl groups per molecule. Such polyhydroxy-polyethers are typically obtained by alkoxylation of appropriate starter molecules, e.g. water, propylene glycol, glycerol, trimethylolpropane, sorbitol, sucrose and the like, with typical alkoxylating agents, such as, for example, propylene oxide or ethylene oxide. Hydroxy carboxylic acids, organic compounds wherein one or more hydroxyl groups of a polyol are replaced with C(═O)—OH functionality and may readily replace diols, triols, and the like in the processes of the present invention, also are intended to be within the scope of the term “polyol”. Similarly, for the purposes of the invention, polyols wherein one or more hydroxyl groups (—OH) are replaced by amino (—NH₂) groups are also intended to be within the scope of the term polyol.

Preferably, the polyols are substituted with two or three hydroxyl groups per molecule, such as, for example, di- and/or trifunctional polypropylene glycols in the molecular weight range from 200 to 6,000. More preferably these polypropylene glycols have a molecular weight range from 400 to 3,000. Alternatively, random or block copolymers of ethylene oxide or propylene oxide may be employed. Also preferably employed are the polytetramethylene glycols of molecular weight range between 200 and 6,000, which are typically prepared by acid polymerization of tetrahydrofuran. More preferably, the polytetramethylene glycols are of molecular weight range between 400 and 4,000.

Other suitable polyols in the present invention include, but are not limited to, liquid polyesters typically prepared by condensation of di- or tricarboxylic acids, such as, for example, adipic acid, sebacic acid, glutaric acid, azelaic acid, hexahydrophthalic acid or phthalic acid, with low molecular weight diols or triols, such as, for example, ethylene glycol, propylene glycol, diethylene glycol, triethylene glycol, dipropylene glycol, 1,4-butanediol, 1,6-hexanediol, 1,10-decanediol, glycerol or trimethylolpropane, are furthermore suitable as polyols.

Another group of liquid polyesters suitable as polyols in the present invention includes the group of polyesters based on ε-caprolactone, also called “polycaprolactones”.

Polyester polyols of oleochemical origin may also be used in the present invention. Such polyester polyols are typically prepared by complete ring-opening of epoxidized triglycerides of a fatty acid mixture comprising at least in part olefinically unsaturated fatty acids with one or more alcohols having from one to about twelve carbon atoms and subsequent partial transesterification of the triglyceride derivatives to give alkyl ester polyols having from one to about twelve carbon atoms in the alkyl radical. Other suitable polyols include, but are not limited to, polycarbonate polyols and dimer diols (Henkel) as well as castor oil and derivatives thereof. The hydroxy-functional polybutadienes such as, for example, those sold under the trade name “poly-bd” may also be employed as polyols for use in the processes of the present invention.

Particularly preferred polyols for use in the processes of the present invention are polyether diols, polyether triols, polyester diols, polyester triols, and mixtures thereof.

The carboxylic acids employed in the present invention react with the polyisocyanates in the presence of catalysts to form amides with concomitant loss of carbon dioxide. The carboxylic acids therefore provide a dual function in the processes by both participating in the formation of the polymer matrix and acting as a blowing agent to foam the polymer matrix with the concomitantly formed carbon dioxide.

As used herein, “carboxylic acid” refers to a moiety having from 2 to about 400 carbon atoms substituted with one or more carboxyl groups (—COOH).

As used herein, “long—chain acid” refers to a carboxylic acid having from about 5 to about 400 carbon atoms and from one to about three carboxyl groups, preferably from about 5 to about 200 carbon atoms, more preferably from about 5 to about 80 carbon atoms, and most preferably from about 5 to about 36 carbon atoms. While carboxylic acids with fewer carbon atoms work, they are less convenient for the purposes of the invention. The carboxyl groups of the long—chain acids may be bonded to saturated or unsaturated, linear or branched alkyl or cycloalkyl radicals or aryl radicals. The radicals may be further substituted with one or more ether, ester, halogen, amide, amino, hydroxyl and urea groups. Preferably, the long—chain acids, such as, for example, naturally occurring fatty acids or fatty acid mixtures, COOH— terminated polyesters, polyethers or polyamides, dimer fatty acids and trimer fatty acids, are liquids at room temperature. Exemplary carboxylic acid groups include, but are not limited to, acetic acid, valeric, caproic, caprylic, capric, lauric, myristic, palmitic, stearic, isostearic, isopalmitic, arachic, behenic, cerotic and melissic acids and the mono- or polyunsaturated acids palmitoleic, oleic, elaidic, petroselic, erucic, linoleic, linolenic and gadoleic acid, adipic acid, sebacic acid, isophthalic acid, terephthalic acid, trimellitic acid, phthalic acid, hexahydrophthalic acid, tetrachlorophthalic acid, oxalic acid, muconic acid, succinic acid, fumaric acid, ricinoleic acid, 12-hydroxy-stearic acid, citric acid, tartaric acid, di- or trimerized unsaturated fatty acids, optionally as a mixture with monomeric unsaturated fatty acids, and optionally partial esters of these compounds. Esters of carboxylic acids substituted with two or more carboxyl groups, or carboxylic acid mixtures which have both COOH and OH groups may likewise also be employed, such as partial esters of trimethylolpropane, glycerol, pentaerythritol, sorbitol, glycol or alkoxylates thereof with adipic acid, sebacic acid, citric acid, tartaric acid or grafted or partially esterified carbohydrates (sugar, starch, cellulose), and ring-opening products of epoxides with carboxylic acids substituted with two or more carboxyl groups.

Preferably, the “carboxylic acid” in the invention is an “hydroxycarboxylic acid”. As used herein, “hydroxycarboxylic acid” refer to monohydroxymonocarboxylic acids, monohydroxypolycarboxylic acids, polyhydroxymonocarboxylic acids and polyhydroxypolycarboxylic acids, including the corresponding hydroxyalkoxycarboxylic acids, wherein “poly” means two or more of the indicated hydroxyl or carboxyl groups. The hydroxycarboxylic acids of the invention have a moiety with from about two to about 600, preferably 8 to 400, and more preferably, from about fourteen to about 120 carbon atoms, which is substituted with one to about nine, preferably about two to about three hydroxyl groups or carboxyl groups. Preferably the moiety is alkyl. The polyhydroxymonocarboxylic acids and the polyhydroxypolycarboxylic acids, including the corresponding hydroxyalkoxycarboxylic acids, are called collectively polyhydroxy-fatty acids. Exemplary dihydroxy-fatty acids that may be preferably used in the present invention and their preparation are disclosed in DE-OS 33 18 596 and EP 237 959, which are expressly incorporated herein by reference.

Other polyhydroxy-fatty acids used according to the invention are preferably derived from naturally occurring fatty acids by, for example, those methods above described. Polyhydroxy-fatty acids with a chain length of about eight to about 100, preferably from about fourteen to about twenty-two carbon atoms are particularly suitable. For industrial uses, naturally occurring fatty acids are usually employed as technical-grade mixtures. These mixtures preferably comprise a portion of oleic acid. They may moreover comprise further saturated, monounsaturated and polyunsaturated fatty acids. Mixtures of polyhydroxy-fatty acids of differing chain length may also be utilized. Pure hydroxy-fatty acids and mixtures thereof derived from animal fats or vegetable oils, which, after processing (ester cleavage, purification stages), have a monounsaturated fatty acid content of >40%, preferably >60%, are also suitable. Non-limiting examples of these commercially obtainable, naturally occurring raw materials, include beef tallow, with a chain distribution of 67% oleic acid, 2% stearic acid, 1% heptadecanoic acid, 10% saturated acids of chain length of twelve to sixteen carbon atoms, 12% linoleic acid and 2% saturated acids of >18 carbon atoms and the oil of the new sunflower (NSf) with a composition of approximately 80% oleic acid, 5% stearic acid, 8% linoleic acid and 7% palmitic acid. After the fatty acid mixtures are epoxidized and ring opened, The resultant products may be subjected to brief distillation in order to reduce the unsaturated fatty acid ester contents, or subjected to more extended purification (e.g. longer-lasting distillation) if desired.

Preferably, the polyhydroxy-fatty acid used according to the invention is derived from the cis or trans monounsaturated fatty acid 4,5-tetradecenoic acid, 9,10-tetradecenoic acid, 9,10-pentadecenoic acid, 9,10-hexadecenoic acid, 9,10-heptadecenoic acid, 6,7-octadecenoic acid, 9,10-octadecenoic acid, 11,12-octadecenoic acid, 11,12-eicosenoic acid, 11,12-docosenoic acid, 12,14-docosenoic acid, 15,16-tetracosenoic acid or 9,10-ximenoic acid, or mixtures thereof. More preferably, the polyhydroxy-fatty acids used according to the invention is derived from oleic acid (9,10-octadecenoic acid).

Polyhydroxy-fatty acids which originate from less frequently occurring unsaturated fatty acids, such as decyl-12-enoic acid, stiling acid, dodecyl-9-enoic acid, ricinoleic acid, petroselic acid, vaccenoic acid, elaeosteric acid, punicic acid, licanic acid, parinaric acid, gadoleic acid, arachidonic acid, 5-eicosenoic acid, 5-docosenoic acid, cetoleic acid, 5,13-docosadienoic acid and/or selacholeic acid, are also suitable.

Polyhydroxy-fatty acids which have been prepared from isomerization products of naturally occurring unsaturated fatty acids are furthermore suitable. The polyhydroxy-fatty acids prepared in this way typically differ only by the position of the hydroxyl or hydroxyalkoxy groups in the molecule. They are in general provided in the form of mixtures, but may be further purified if desired.

Ring opening reaction of an epoxidized fatty acid derivative with a polyol typically provides a polyhydroxy-fatty acid with an hydroxyalkoxy substituent. They are typically liquid at room temperature and may easily be mixed with the other components in the reaction. Preferably, the hydroxyl groups of the hydroxyalkoxy group are separated from the carboxyl group by at least one, more preferably by at least three, and even more preferably by at least 6 CH₂ units. Preferably these polyhydroxy-fatty acids with an hydroxyalkoxy substituent are derived from primary difunctional alcohols having from two up to about twenty-four, more preferably from two up to about twelve carbon atoms are preferred. Exemplary diols include, but are not limited to ethanediol, propanediol, butanediol, pentanediol, hexanediol, dodecanediol, polypropylene with a degree of polymerization of two to forty, polytetrahydrofurandiol with a degree of polymerization of two to forty, polybutanediol with a degree of polymerization of two to forty, polyethylene glycol with a degree of polymerization of two to forty, or copolymerization products thereof. More preferably they include 1,2-ethanediol, 1,4-butanediol, 1,6-hexanediol, polypropylene glycol with a degree of polymerization of two to forty, polytetrahydrofurandiol with a degree of polymerization of two to forty, polybutanediol glycol with a degree of polymerization of two to forty, or polyethylene glycol with a degree of polymerization of two to forty, or copolymerization products thereof . Even more preferably the diols include polypropylene glycol with a degree of polymerization of two to forty, polytetrahydrofurandiol with a degree of polymerization of two to forty, or copolymerization products thereof. Even more preferred in each case is a degree of polymerization of about two to twenty. This applies in particular if these compounds in each case have a degree of polymerization of about 2 to 20 units. Alternatively, triols or alcohols with more hydroxyl functionality may also be employed for the ring-opening, e.g., glycerol and trimethylolpropane, as well as their adducts of ethylene oxide and/or propylene oxide with molecular weights of up to 1,500. Polyhydroxy-fatty acids with more than 2 hydroxyl groups per molecule are consequently obtained.

Polyhydroxy-fatty acids also include the ring-opening products of epoxidized unsaturated fatty acids with water and the crosslinking products that correspond to reaction of the ring-opened products with additional epoxide molecules. Exemplary non-limiting dihydroxy-fatty acids include, but are not limited to, 9,10-dihydroxypalmitic acid, 9,10-dihydroxystearic acid and 13,14-dihydroxybehenic acid.

Alternatively, hydroxycarboxylic acids, e.g., citric acid, ricinoleic acid, 12-hydroxystearic acid or lactic acid, may be employed in place of polyols in the ring opening reaction. Ester groups are then formed instead of ether groups. Amines, amines which carry hydroxyl groups or aminocarboxylic acids may likewise be employed for the ring-opening.

Polyunsaturated fatty acids are also suitable, such as, for example, linoleic acid, linolenic acid or ricinenoic acid. Aryl substituted carboxylic acids, such as, for example, cinnamic acid may also be employed.

In order to avoid demixing of the polyol components employed, especially if hydroxyl-functionalized natural oils are used, it is necessary to employ amino compounds in a fixed molar mixing ratio with solubilizing carboxylic acids. The fixed molar ratio of the amino compounds to solubilizing carboxylic acids should be 1:3 to 3:1. Mixtures prepared within this range have the effect of enhancing solubilization between the polyalcohols and water without adversely affecting the foamable composition's measurable foam properties. When the claimed ratios of amines to solubilizing carboxylic acids are used, the compositions according to the invention may be processed without renewed stirring immediately before use. Suitable amino compounds include, but are not limited to di- and polyamines, such as, for example, diethylenetriamine and longer-chain homologues thereof with at least two amino groups per molecule, hydroxy-functional polyamines, such as, for example, N-(2-aminoethyl)ethanolamine. Piperazine and aminoalkyl- or hydroxyalkyl-substituted piperazines are also suitable as amino compounds. Preferably, the amino compound is aminoethylpiperazine.

As used herein, a “solubilizing carboxylic acid” is a straight-chained or branched, saturated or unsaturated carboxylic acid having from about six to about thirty carbon atoms. Preferably, solubilizing carboxylic acids have from about six to about twenty-four carbon atoms. Exemplary solubilizing carboxylic acids include, but are not limited to, those derived from rape seed oil (oleic acid, linoleic acid, linolenic acid, erucic acid: “rape seed fatty acid”) and isostearic acid.

The foaming reaction caused by concomitant carbon dioxide formation may be effected both by reaction of isocyanate groups of the polyisocyanate with the carboxylic acids groups of the carboxylic acids and optionally additionally by reaction of the isocyanate groups with water.

The water content of the “polyol component” may be between 0.1 and 10 wt. %, and is preferably between 0.3 and 5 wt. %. As used herein, “polyol component” refers to a mixture of all the components in the foamable composition except the polyisocyanate.

When facile concomitant formation of carbon dioxide from the isocyanate-carboxylic acid reaction at room temperature is required, it is expedient to use an amine-substituted pyridine, N-substituted imidazole, or mixture thereof as catalyst. The amount of the pyridine or imidazole catalyst to be employed is between 0.0001 and 1.0, preferably between 0.01 and 0.5 equivalents of the pyridine or imidazole catalyst per equivalent of isocyanate functionality. Non-limiting examples of these catalysts include 1-methylimidazole, 2-methyl-1-vinylimidazole, 1-allylimidazole, 1-phenylimidazole, 1,2,4,5-tetramethylimidazole, 1-(3-aminopropyl)imidazole, pyrimidazole, 4-dimethylamino-pyridine, 4-pyrrolidinopyridine, 4-morpholino-pyridine, 4-methylpyridine and N-dodecyl-2-methyl-imidazole. In reactions where only water is employed to foam the composition, the addition of the abovementioned pyridine or imidazole catalyst may be omitted. However, if a carboxylic acid is the sole blowing agent, the pyridine or imidazole catalyst, or mixture thereof must be employed in combination with a basic or organometallic catalyst listed below, in order to facilitate the reaction.

The amount of reaction component polyisocyanate, polyol, polyamine, carboxylic acid and water in the foamable composition is chosen such that the polyisocyanate is employed in excess. The ratio of equivalents of NCO to the total of OH, NH and COOH groups is from about 10:1 to about 1.01:1, preferably 5:1 to 1.05:1, and more preferably from about 2:1 to about 1.05:1. The range of total equivalents of polyol plus polyamine to total equivalents of water plus carboxylic acid is between about 20:1 and 1:20. If polycarboxylic acids or hydroxy- or aminocarboxylic acids are employed, the addition of a polyol or polyamine may be omitted entirely. Where no polyol, polyamine or water participates in the reaction, that is to say, the isocyanates are reacted with the carboxylic acids, 0.1 to 1 equivalents, preferably 0.8 to 1 equivalents, of carboxylic acid and 0.0001 to 1.0 equivalents, preferably 0.001 to 0.5 equivalents of amine-substituted pyridine or N-substituted imidazole catalyst, or mixture thereof are present per equivalent of isocyanate.

Where polyfunctional isocyanates are predominantly reacted with hydroxycarboxylic acids, the abovementioned amine-substituted pyridine or N-substituted imidazole catalyst, or mixture thereof should preferably be employed in a concentration of 0.05 to 15 weight %, in particular 0.5 to 10 weight %, based on the sum of weights of hydroxycarboxylic acid and isocyanate.

Additional catalyst may be employed in conjunction with the abovementioned pyridine and imidazole derivatives. Organometallic compounds, such as tin(II) salts of carboxylic acids, and strong bases, such as alkali metal hydroxides, alcoholates and phenolates, e.g. tin(II) acetate, tin(II) ethylhexoate or tin(II) diethylhexoate, may be used to facilitate reactions of isocyanate with water or polyol. The dialkyl-tin(IV) carboxylates are a preferred class of catalyst. The carboxylates have two to about thirty-two, preferably about ten to about thirty-two, and more preferably about fourteen to about thirty-two carbon atoms. Dicarboxylic acids (as their dicarboxylate dianions) may also be employed. Exemplary carboxylic and dicarboxylic acids include, but are not limited to, which may be expressly mentioned are: adipic acid, maleic acid, fumaric acid, malonic acid, succinic acid, pimelic acid, terephthalic acid, phenylacetic acid, benzoic acid, acetic acid, propionic acid, 2-ethylhexanoic, caprylic, capric, lauric, myristic, palmitic and stearic acid. Preferably, the carboxylic acids are 2-ethylhexanoic, caprylic, capric, lauric, myristic, palmitic and stearic acid. Non-limiting examples of tin (II) and dialkyl tin (IV) catalysts include dibutyl-tin diacetate, dibutyl-tin maleate, dibutyl-tin bis-(2-ethylhexoate), dibutyl-tin dilaurate, dioctyl-tin diacetate, dioctyl-tin maleate, dioctyl-tin bis-(2-ethylhexoate) and dioctyll-tin dilaurate, tributyltin acetate, bis(β-methoxycarbonylethyl)tin dilaurate and bis(β-acetyl-ethyl)tin dilaurate.

Tin oxides, tin sulfides and tin thiolates may also preferably be used as catalyst. Non-limiting examples include bis(tributyltin) oxide, bis(trioctyltin) oxide, dibutyl tin bis(2-ethyl-hexylthiolate), dioctyltin bis(2-ethyl-hexylthiolate), dibutyltin didodecylthiolate, dioctyltin didodecylthiolate, bis(β-methoxycarbonyl-ethyl)tin didodecylthiolate, bis(β-acetyl-ethyl)tin bis(2-ethylhexylthiolate), dibutyltin didodecylthiolate, dioctyltin didodecylthiolate, butyltin tris(thioglycollic acid 2-ethylhexoate), octyltin tris(thioglycollic acid 2-ethylhexoate), dibutyltin bis(thioglycollic acid 2-ethylhexoate), dioctyltin bis(thioglycollic acid 2-ethylhexoate), tributyltin (thioglycollic acid 2-ethylhexoate), trioctyltin (thioglycollic acid 2-ethylhexoate) and butyltin tris(thioethylene glycol 2-ethylhexoate), octyltin tris(thioethylene glycol 2-ethylhexoate), dibutyltin bis(thioethylene glycol 2-ethylhexoate, dioctyltin bis(thioethylene glycol 2-ethylhexoate), tributyltin (thioethylene glycol 2-ethylhexoate), trioctyltin (thioethylene glycol 2-ethylhexoate), a catalyst with the general formula Rₙ₊₁Sn(SCH₂CH₂OCOC₈H₁₇)₃₋ₙ, wherein R is an alkyl group having from about four to about eight carbon atoms and n is an integer from zero to two, bis(β-methoxycarbonyl-ethyl)tin bis(thioethylene glycol 2-ethylhexoate), bis(β-methoxycarbonyl-ethyl)tin bis(thioglycollic acid 2-ethylhexoate), bis(β-acetyl-ethyl)tin bis(thioethylene glycol 2-ethylhexoate) and bis(β-acetyl-ethyl)tin bis(thioglycollic acid 2-ethylhexoate).

If crosslinking of the polyurethane matrix is desired, the trimerization reaction of the isocyanate groups with themselves or with urethane and urea groups to give allophanate or biuret groups may be facilitated by the addition of a trimerization catalyst. Typically, these trimerization catalysts include quaternary ammonium salts dissolved in ethylene glycol, such as, for example, DABCO TMR-2 from Air Products and Chemicals, Inc., Allentown, Pa.

Alkyl tertiary amines are also effective for crosslinking the polyurethane matrix. Tertiary amines which additionally carry groups which are reactive toward the isocyanates, such as, for example hydroxyl and/or amino groups, and cycloalkyl tertiary amines are preferred. Examples of alkyl tertiary amines include, but are not limited to, dimethylmonoethanolamine, diethylmonoethanolamine, methylethylmonoethanolamine, triethanolamine, trimethanolamine, tripropanolamine, tributanolamine, trihexanolamine, tripentanolamine, tricyclohexanolamine, diethanolmethylamine, diethanolethylamine, diethanolpropylamine, diethanolbutylamine, diethanolpentylamine, diethanolhexylamine, diethanolcyclohexylamine, diethanolphenylamine and ethoxylation and propoxylation products thereof, diaza-bicyclo-octane (DABCO), triethylamine, dimethylbenzylamine (DESMORAPID DB, BAYER), bis-dimethylaminoethyl ether (Catalyst A 1, UCC), tetramethylguanidine, bis-dimethylaminomethyl-phenol, 2,2′-dimorpholinodiethyl ether, 2-(2-dimethylaminoethoxy)ethanol, 2-dimethylaminoethyl 3-dimethylaminopropyl ether, bis(2-dimethylaminoethyl) ether, N,N-dimethylpiperazine, N-(2-hydroxyethoxyethyl)-2-azanorboranes, TEXACAT DP-914 (Texaco Chemical), N,N,N,N-tetramethylbutane-1,3-diamine, N,N,N,N-tetramethylpropane-1,3-diamine and N,N,N,N-tetramethylhexane-1,6-diamine.

Tertiary amine catalyst in oligomerized or polymerized form, such as, for example, N-methylated polyethyleneimine is also effective in crosslinking the polyurethane matrix.

In addition to the abovementioned components, the foamable composition also comprises low-boiling hydrocarbon. Preferably these hydrocarbons have from about three to about 5 carbon atoms. Even more preferably, the low-boiling hydrocarbon is cyclopentane. The weight content of low-boiling hydrocarbons in the reaction mixture is 1.0 to 15%, but the hydrocarbons are always employed in combination with water, fatty acids or mixtures thereof as blowing agents. Cyclopentane has a boiling point of 49° C. and therefore in principle has the disadvantage that it condenses at low temperatures. Any reduced pressure that may arise in the foam cells as a result of cyclopentane's relatively low condensation point, can be counteracted by increasing the bulk density. Although non-cyclic pentanes and other shorter-chain hydrocarbons have lower boiling points than cyclopentane and thereby maintain more favorable foam cell pressure, cyclopentane has a significantly lower thermal conductivity, and thus is preferred in some embodiments of the present invention. Loss of the non-cyclic pentanes and other shorter-chain hydrocarbons during mixing with the fillers through volatilization may be reduced by increasing the level of castor oil in the reaction mixture or by the addition of wetting and dispersing agents, such as e.g. BYK W 968 and 9010, available from BYK-Chemie GmbH, Wesel, Germany.

In addition to the amide groups formed from reaction of carboxylic acid with isocyanate, the foamed layer produced according to the invention also has urethane groups from the reaction of isocyanates with polyols or polyhydroxycarboxylic acids. The foamed layer furthermore contains urea groups from the reaction of isocyanates with water optionally present, or with polyamines or aminocarboxylic acids that may be present in the foamable composition. The foamed layers also contains ester groups or ether groups from the polyol employed.

In a preferred embodiment, the foamable composition for the preparation of the foamed polyurethane layer comprises a high content of filler, in addition to the abovementioned binder constituents. In addition to the conventional fillers of polyurethane chemistry, such as calcium carbonate in the form of precipitated and/or ground chalk or as ground limestone, it is also possible to employ here as the filler dolomite (CaMg(CO₃)₂), barium sulfate (barite), aluminurn oxide, hydrated aluminum oxide and also quartz sand, dried abraded stone sediment, wood chips, cellulose fibers, foam waste, rubber flour, rubber chips, foamed glass granules or ground glass. Compact waste from plastics, cable waste, short fibers of glass and rock wool and synthetic and naturally occurring short fibers are furthermore suitable as fillers.

The filler content in the foamable composition described immediately above may make up as much as 80 wt. % of the foamed layer. If the water content of the filler is high, it may be necessary to dry the filler in a typical manner. The filler-added foamable composition may optionally be colored with suitably colored abraded stone sediments, and for this black-, red- or grey-colored quartz flours or abraded stone sediments may be employed. Before being admixed, the filler may optionally be surface-treated with adhesion promoters, in particular organofunctional silanes or titanates, so that the filler is better dispersed and better bonded within the polyurethane matrix.

A particularly preferred filler is quartz sand, which should have a defined grain size distribution for improved flow properties of the polyurethane reaction mixture before curing. Fillers with a Fuller distribution in which the grain size mixture satisfies the following mathematical formula

D=\sqrt{d/dₘₐₓ}*100

wherein d is the variable grain size in mm, dₘₐₓ is the diameter of the maximum grain in mm and D is the sieve passage of the filler through the test sieve in %, are particularly preferred. As is known in the art, such a grain mixture theoretically has the effect of completely filling the space, i.e., a degree of filling of 100%. This results in optimum flow properties and optimum binding of the filler into the polymeric foam matrix. However, prerequisites for such a theoretically complete filling of the space are:

availability of all fillers between mesh width 0 and mesh width dₘₐₓ in the calculated content and

a complete mixing quality.

In practice, both requirements usually cannot be fulfilled, and filler compositions which have a “gap grading” are therefore usually used. This term comes from the fact that in this type of mixture there is a mixing gap between the coarse grain range and the fine grain range. Such fillers with gap gradings are also preferred filler mixtures for the composite bodies according to the invention. Quartz sand types such as are available under the designation F31, F32, F34 and F36 from Quarzwerke GmbH, Frechen, Germany, are very particularly preferred. These have an average grain size of 0.33; 0.24; 0.20 and 0.16 mm. These may then optionally be mixed with fine-grained quartz flours, such as MILLISIL W12 (average grain size 16 μm) or SIKRON SF (quartz flour, average grain size 10 μm).

For better incorporation of the filler, the composition according to the invention may comprise wetting or dispersing agent. Wetting or dispersing agent improve incorporation of the filler and the flow of the polyurethane foamable composition with the quartz sand, the abraded stone sediment or the ground glass into the edge regions of the mould to be cast. Non-limiting examples of such wetting and dispersing agents include those available from BYK-Chemie GmbH, Wesel, Germany, under the designations BYK W 968, W 9010, A 525 or A 530.

As used herein, a “shaped mineral body” is a slab or preformed semi-finished product derived from igneous rocks such as, for example, granite, basalt, sylenite, diabase, tuff, liparite, diorite, andesite or picrite, from sedimentary rocks such as, for example, sandstone or from metamorphic rocks such as, for example, soapstone or marble. In addition to the abovementioned shaped mineral bodies of natural rocks, synthetic stones based on concrete or synthetic resin (polyester) may also be used. The thickness of the stone slab or of the semi-finished product used depends on the intended use and the load to be expected. The thickness is typically between about eight and about twenty millimeters, preferably between about ten and about fourteen millimeters.

If better adhesion between the stone slab and the foamed layer is desired, an adhesive may be applied to the stone slab before introduction of the optionally filler-added foamable composition into the mould. The adhesive employed may be any structural adhesive based on polyurethanes or epoxides, and preferably is a polyurethane adhesive which substantially comprises the components of the abovementioned foamable composition having no blowing agent.

A reinforcing mat or a reinforcing nonwoven may be incorporated between the stone slab and polyurethane foamed layer, on the reverse of the polyurethane foamed layer (i.e. the side facing away from the stone slab), or both, in order to increase the stability of the composite slab. This reinforcing mat comprises a glass fiber fabric or glass fiber nonwoven, or synthetic or naturally occurring fiber materials.

It may be expedient to employ foam stabilizers which are known to one skilled in the art, based on siloxane/oxyalkylene copolymers such as, for example, those marketed under the trade name TEGOSTAB by Goldschmidt. In principle, however, it is also possible to use other silicone-free stabilizers, such as, for example, LK-221, LK-223 and LK-443 from Air Products and Chemicals, Inc., Allentown, Pa., or betaine emulsifiers.

If individual components of the foamable composition have relatively high water contents, it may be appropriate to use desiccants in the form of molecular sieve pastes. At very high or varying water contents, these constituents should be dried beforehand, if necessary.

For easier removal of the shaped bodies from the mould after production thereof, release agents which are known to one skilled in the art may be employed in the metal mould, such as, for example, Acmos release agent for PU with the type designations 39-5001, 39-4487, 37-3200 and 36-3182. Alternatively, removal of the composite body from the mould may be effected by providing the metal mould with a layer of fluorinated polymers as a release agent (Teflon® coating).

The composite bodies, produced by the processes according to the invention, of shaped mineral bodies and polyurethane foamed layers are particularly suitable for use as facade panels, floor panels or wall panels, due to their low thermal conductivity and therefore high thermal insulation capacity.

The invention is further illustrated by the following examples.

### EXAMPLE 1 (COMPARATIVE EXAMPLE)

| | Weight contents in % |
|---|---|
| a) Polyol component | |
| Castor oil | 65.0 |
| Glycerol | 10.0 |
| Polypropylene glycol, Mn 400 | 12.22 |
| Rape seed fatty acid | 10.00 |
| Water | 1.3 |
| TEGOSTAB B 8404 | 1.0 |
| N-Methylimidazole | 0.08 |
| Dibutyltin dilaurate | 0.08 |
| b) Isocyanate component | |
| Diphenylmethane 4,4′-diisocyanate | 110.00 |
| (crude MDI) | |

The polyol component and quartz sand F31 (Quarzwerke GmbH, Frechen, Germany) are mixed in a mixing ratio of 100:170. The isocyanate is added to this mixture and the mixture is homogenized again. The ratio of polyol:isocyanate is 100:110. This mixture is introduced into a metal mould which has been impregnated with release agent and may be closed with a lid. A granite slab 1 cm thick is on the base of this mould. The reaction mixture is introduced into the mould, distributed uniformly and covered with a glass fiber fabric. After 45 min, the stone composite slab may be removed from the opened mould. Note: If allowed to stand, the initially mixed polyol component of this example demixes into two phases occurs after a short standing time.

### EXAMPLE 2 (ACCORDING TO THE INVENTION)

| | Weight contents in % |
|---|---|
| a) Polyol component | |
| Castor oil | 60.9 |
| Glycerol | 9.6 |
| Polypropylene glycol, Mn 400 | 9.42 |
| Rape seed fatty acid | 5.0 |
| Water | 1.0 |
| TEGOSTAB B 8467 | 2.0 |
| N-Methylimidazole | 0.40 |
| Dibutyltin dilaurate | 0.08 |
| Cyclopentane | 10.00 |
| Aminoethylpiperazine | 1.6 |
| b) Isocyanate component | |
| Diphenylmethane 4,4′-diisocyanate | 100.00 |
| (crude MDI) | |

The polyols, the water, the wetting agent, the amine and the catalysts are first mixed, the rape seed fatty acid is then added, the resultant polyol component is stirred intensively and thereafter cyclopentane is added. A clear liquid results, which does not separate into phases after the mixing operation. This distinguishes the example according to the invention from example 1, since in the case of the polyol mixture of example 1 demixing into two phases occurs after a short standing time.

This system is processed as described in example 1, but the ratio of polyol:isocyanate is 100:100.

The thermal conductivity of each of the two slab-type composite bodies (Examples 1 and 2) was determined in accordance with DIN 52616 at an average specimen temperature of 23° C. Composites with a 1 cm granite and 3 cm foam thickness were employed. The thermal conductivity of the composite slab of example 1 was found to be 0.040 W/mK. By employing the processes of the present invention, the thermal conductivity was reduced by 17.5% to a value of 0.033 W/mK.

What is claimed:

1. A process for the production of a composite body comprising:
introducing into a closed, substantially unheated, mould a foamable composition comprising at least one polyisocyanate, and at least one polyol, together with long—chain acid, amine and low—boiling hydrocarbon;
foaming the composition in the mould under pressure intrinsic to the foaming reaction to form a foamed layer; and;
adhering the foamed layer to a shaped mineral body to provide the composite body.

2. The process according to claim 1 wherein the shaped mineral body is adhered to the foamed layer with a layer of polyurethane adhesive similar to the foamable composition having no blowing agent.

3. The process according to claim 2 wherein a woven or non-woven reinforcing mat or layer is adhered between the foamed layer and the shaped mineral body.

4. The process according to claim 3 wherein a woven or non-woven reinforcing mat or layer is disposed upon the foamed layer on the side away from the shaped mineral body.

5. The process of claim 1 wherein the foamable composition further comprises at least one filler.

6. The process according to claim 1 wherein the foamable composition comprises up to about 80% filler.

7. The process according to claim 1 wherein the provision of the composite body is produced in essentially a single operation comprising the steps of:
placing the shaped mineral body into the mould;
introducing the foamable composition into the mould containing the shaped mineral body;
enclosing the mould;
effecting foaming of the foamable composition in the closed mould containing the shaped mineral body; and
removing the composite body from the mould.

8. The process according to claim 7 wherein a layer of adhesive is applied to the shaped mineral body before introduction of the foamable composition.

9. The process according to claim 8 wherein a woven or non-woven reinforcing mat or layer is applied to the layer of adhesive prior to introduction of the foamable composition.

10. The process according to claim 7 wherein a woven or non-woven reinforcing mat or layer is disposed upon the foamed layer on the side away from the shaped mineral body.

11. The process according to claim 5 wherein the filler is calcium carbonate in the form of chalk or ground limestone, calcium magnesium carbonate, barium sulfate, aluminum oxide, hydrated aluminum oxide, quartz sand, dried abraded stone sediment, ground glass, foamed glass granules, wood chips, wood flour, cellulose fibers, foam waste, rubber flour, rubber chips, compact waste from plastics, cable waste, short fibers of glass or rock wool, synthetic polymer fibers, natural fibers or mixtures thereof.

12. The process according to claim 1 wherein the foamable composition further comprises at least one catalyst, carboxylic acid, water, up to about 5 weight percent, amine, foam stabilizer, wetting agent and dispersing agent.

13. The process according to claim 1 wherein the low boiling hydrocarbon has from three to five carbon atoms.

14. The process of claim 1 wherein the low boiling hydrocarbon is cyclopentane.

15. The process according to claim 1 wherein the foamable composition further comprises filler having a particle size distribution corresponding to a Fuller distribution or a gap grading.

16. A composite body comprising a shaped mineral body adhered to a foamed layer formed by introducing into a closed, substantially unheated, mould a foamable composition comprising at least one polyisocyanate, and at least one polyol, together with long—chain acid, amine and low—boiling hydrocarbon; and
foaming the composition in the mould under pressure intrinsic to the foaming reaction to form a foamed layer.

17. The composite body of claim 16 wherein the shaped mineral body is adhered to the foamed layer with a polyurethane adhesive similar to the foamable composition having no blowing agent.

18. The composite body of claim 16 wherein a woven or non-woven reinforcing mat or layer is adhered between the foamed layer and the shaped mineral body.

19. The composite body of claim 16 wherein a woven or non-woven reinforcing mat or layer is disposed upon the foamed layer on the side away from the shaped mineral body.

20. The composite body of claim 16 wherein the foamable composition further comprises at least one filler.

21. The composite body of claim 20 wherein the foamable composition comprises up to about 80% filler.

22. The composite body of claim 20 wherein the filler is calcium carbonate in the form of chalk or ground limestone, calcium magnesium carbonate, barium sulfate, aluminum oxide, hydrated aluminum oxide, quartz sand, dried abraded stone sediment, ground glass, foamed glass granules, wood chips, wood flour, cellulose fibers, foam waste, rubber flour, rubber chips, compact waste from plastics, cable waste, short fibers of glass or rock wool, synthetic polymer fibers, natural fibers or mixtures thereof.

23. A wall or floor building panel comprising the composite body of claim 16.
